(19) United States
(12) Patent Application Publication
(10) Pub. No.: US 2008/0042456 A1
(43) Pub. Date: Feb. 21, 2008

(54) Pickup device for animal waste

(76) Inventor: Tony Patel, Naples, FL (US)

Correspondence Address: Tony Patel, P.O. Box 1491, Naples, FL, 34106, US

(21) Appl. No.: 11/503,885

(22) Filed: Aug. 15, 2006

(51) Int. Cl. A01K 29/00

(52) U.S. Cl. 294/1.3

(57) ABSTRACT

A pickup device is used for picking up droppings from a pet that are left on the ground. The device consists of a handle having an upper and a lower end. At the upper end are located triggers to operate elements at the lower end. The elements at the lower end consist of a pair of outer clam shells which are opened or closed from the triggers at the upper end. The outer clam shells have located therein a second pair of claim shells having central openings therein. The second pair of clam shells are always biased into an open position and are operated in conjunction with the operation of the first or outer clam shells. The second pair is rotated within the first pair by an electric motor to twist a paper bag into a pile once the pet waste has been trapped therein.

### FIELD OF THE INVENTION

An animal waste pickup device having a long handle carried by an animal handler so that any animal droppings do not have to be manually handled.

### BACKGROUND OF THE INVENTION

The invention pertains to an animal waste pickup device. that can be used in an easy procedure and in a completely sanitary manner. Pet owners and other observers are quite familiar with city, county, and other local ordinances that require pet owners, who take their pets for walks, to pick up the pet's or animal's droppings such as feces to keep the environment in a sanitary condition. This ordinance, including common sense, applies to public properties as well as private properties. With the increased public concern over sanitation and a cleaner environment, many municipalities have required that dog owners clean up after the animals have defecated on public properties. Although this is more pleasant for the public, it leaves the dog owner with an extremely unpleasant task. Many different scooping devices have been provided to hold open a bag while the feces are scraped or scooped therein. Various devices are known to accomplish the above mandate. It is known to use plastic gloves that are worn on a hand which simply pick up the droppings and by inverting the glove or by simply stripping the glove off the hand to invert the same, the dropping can be disposed of in a sanitary manner. Others simply carry a small bucket or similar container to accomplish the same task as noted above. Then there are other more complicated devices which accomplish the pick up and disposal of animal droppings in a completely sanitary manner.

U.S. Pat. No. 4,097,082 describes a device which accomplishes the above noted task. The implement described in the above noted patent consists of an elastomeric band to automatically close over the mouth of a flexible wrapper which is operated by two side plates that will swing inwardly at their bottom to thereby grab the flexible wrapper having the animal dropping therein, to keep the it therein and to thereafter dispose of the same, all in a sanitary manner.

U.S. Pat. No. 5,628,537 shows a similar device. This patent discloses a device which also uses a pair of jaws that are pivotally attached to one end of a long handle. An elongated sleeve is connected to the jaws around the handle. When the jaws are locked open, a bag clip engages the closed end of an ordinary thin plastic bag while the open end of the bag is inverted over the edges of the jaws. To pick up the dog feces, the user positions the bag over the waste, makes the jaws to contact with the ground, rotates the sleeve to unlock a sliding motion and moves the sleeve downward on the handle. This closes the jaws and encloses the waste within the bag to be disposed of at a later time and in a sanitary manner.

U.S. Pat. No. 6,305,322 discloses a waste pickup device which a cross of flexible material at one end of a handle. The cross with claws thereon will accept a sheet of paper. When the device is used to pick up animal droppings, the cross with its claws is placed over the animal waste and then the cross is pulled back into a sleeve at the lower end of a handle and as the cross collapses into the sleeve, the waste is picked up and disappears into the sleeve to be disposed of.

### BRIEF DESCRIPTION OF THE INVENTION

The invention at hand is a very efficient and sanitary way of collecting and disposing of animal waste. The inventive device is designed to simplify the above noted task. The device consists of a long handle having control implements within an easy reach of a user's hands The bottom of the handle has a first set of an openable type clam shell pair that has alligator type claw teeth at a bottom of each half of the pair of clam shells.

At the interior surface of each half of the clam shells, there are retention knobs that will retain appropriate paper material ready to be used when the need arises. There is a further and second set of clam shells within the first set. The second set opens and closes in conjunction with the first set of shells.

The second pair is hinged to a yoke of an electric motor but is always biased into an open position by a spring on the yoke of the motor. The second set of clam shells is opened and closed by the operation of the first set of clam shells. The second half of the pair of clam shells, each half clam shell is designed as a frame. This way, when the appropriate paper is applied to the interior of the pair of clam shells, the paper will be located within the second pair of clam shells but because of the frame configuration will adhere to the retention knobs of the first pair of shells. When any animal droppings have been picked up, a trigger at the other end of the handle will close the both pairs of the shell and the droppings will be trapped therein. A button at the other end of the long handle will activate the electric motor whereby the rotation of the second pair of shells will wrap the droppings within the paper to be readily disposable when both pairs of the shells are opened again.

### BRIEF DESCRIPTION OF THE DRAWINGS

FIGS. 1, 2 and 3 show the long handled device in various operating positions;

FIG. 4 is an exploded and perspective view of the elements of the device;

FIG. 5 shows the upper end of the long handle;

FIG. 6 shows the individual elements at the lower end of the long handle.

### DETAILED DESCRIPTION OF THE INVENTION

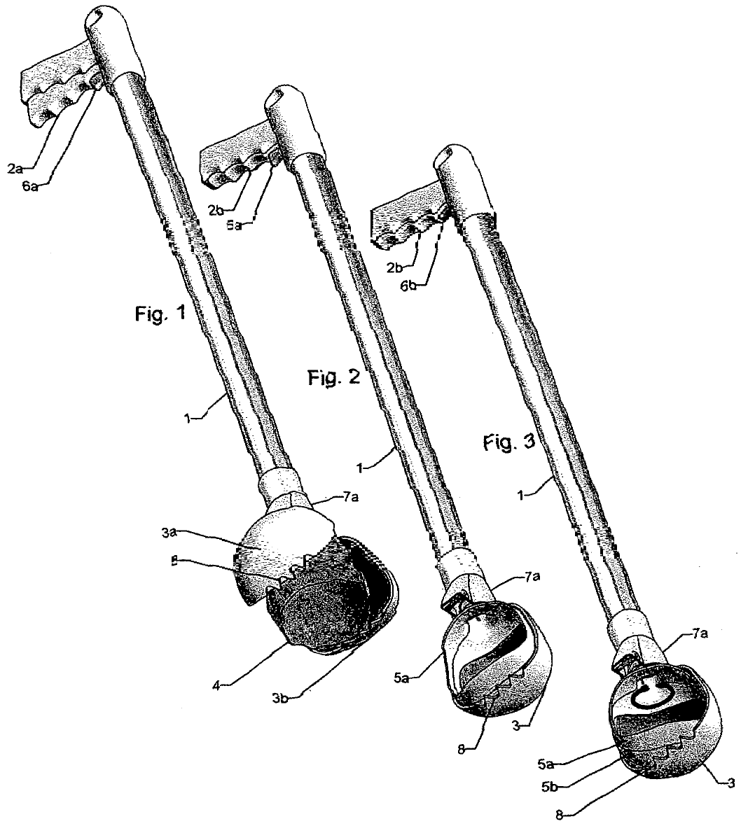

FIGS. 1, 2 and 3 show a long handle 1 having upper and lower ends. At the upper end of the handle 1 there is located a trigger handle 2a and an electrical manipulating switch 6a to be described below.

The lower end of the handle 1 shows two pairs of claim shells 3a and 3b which are hinged to the housing 7a. FIG. 1 shows a bag 4 of appropriate paper that will be located within the pair of outer shells 3a and 3b. Located within the outer or first pair of shells is a second pair of shells 5a and 5b.

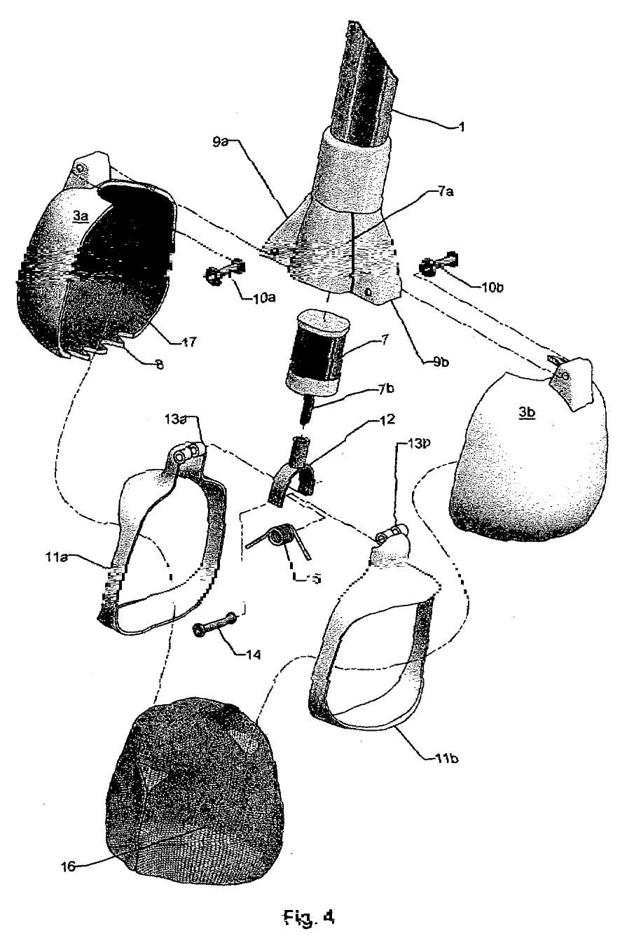

FIG. 4 is an exploded and perspective view of the mounting and the operation of the device. In FIG. 4, the pair of the first and outer clam shells are shown as 3a and 3b. Both of the shells 3a and 3b are hinged to the housing 7a at the lower end of the handle 1 by way of hinge pins 10a and 10b. The opening and closing of these shells 3a and 3b is controlled by the trigger handle 20 at the top of the handle 1. Within the housing 7a there is located an electric gear motor 7 having a drive shaft 7b. A yoke 12 is attached to the motor shaft 7b to be rotated thereby when the need arises. The two second or inner clam shells (shown as 11a and 11b in this Fig.) are hingedly attached to the yoke 12 by way of the hinge pin 14. Interposed between the two second pair clam shells 11a and 11b is a spring 15 which is held in place by the hinge pin 15 and it is biased in such a manner that the spring 15 always tends to keep the second pair of clam shells in an open position. This way, the second pair of clam shells will always follow the opening or closing movement of the first pair of clam shells. It should also be noted that each clam shell of the pair of the second clam shells 11a and 11b are designed as a frame having a central opening therein. When the first pair or outer clam shells 3a and 3b are in an open position, so will be the second pair of claim shells 11a and 11b because of the bias of the spring 15, a paper bag for collecting the animal droppings can be placed within the inner pair of shells. It then will be fastened to the inner surface of the first or outer pair of clam shells. The fastening is the result of friction knobs 17 that are located on the inner surface of each of the outer clam shells. The shading 17 indicates the presence of such knobs. The knobs may be part of the well known hook and loop fasteners or may be tiny mushroom heads made by the 3MM Company.

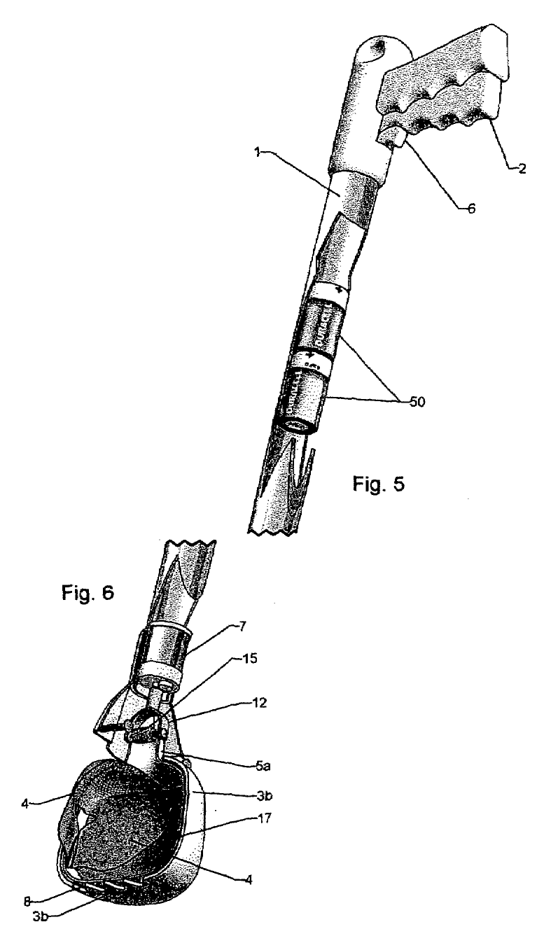

FIG. 5 shows the upper end 1 of the pickup device. 2 illustrates the trigger 2 to operate the clam shells located at the bottom of the handle. Also located at the top of the handle 1 is a push button 6 which, when pushed, will operate the gear motor 7. The requisite batteries to supply energy to the motor 7 are also located in this location on the handle 1. The operation of these elements will be described below.

FIG. 6 shows the bottom of the device in a break-away fashion but only half of the pickup system is shown. The same reference characters of previous Figs. are shown. To this end, the gear motor 7 is shown with the yoke 12 attached to the motor shaft 7b. The yoke 12 also shows how one half 3b of the outer pair of clam shells is hingedly attached to the housing 7a (FIG. 4). The yoke 12 has attached thereto the one half 5a of the second pair of clam shells. The paper bag 4 is symbolically shown prior to being attached to the friction knobs 17 in the interior of the first or outer shell casing 3b. Also note the presentation of the alligator teeth 8 on both the outer shells 3a and 3b.

### Operation

To prepare the pickup device, the trigger 2 is opened and the first or outer clam shells 3a and 3b are opened together with the second or inner pair of clam shells 11a and 11b (FIG. 4). At this point the paper bag 4 (FIG. 6) or 16 (FIG. 4) is placed within the second pair 11a and 11b of clam shells. The paper of the paper bag 16 is now adhered to the knobs 17 on the inner surface of each of the clam shells 3a and 3b. The reason why the paper bag can be adhered to the friction knobs 17 is because both of the halves of the pair of the second clam shells have an opening in the center thereof so that the paper can pass there through. The device is now ready for its intended use.

When taking a pet out for a walk any droppings occasioned by the pet can now be picked up simply by placing the outer pair 3a and 3b of clam shells under the dropping. By now pulling on the trigger 2 the two halves of the outer pair of the shell clams will now move together to close the device. With the aid of the alligator teeth 8, the dropping will be scraped from the ground and will be trapped inside the second pair of clam shells which moved together also as the first pair moved together. It was mentioned above that the electric motor 7 is a gear drive motor so that the shaft 7b can turn very slowly when the push button 6 (FIG. 5) is activated. The reason is that the second pair of clam shell with the bag and the dropping contained therein should not be turning or spinning at a high speed which would tear the bag apart. A few slow turning rotations are sufficient to twist the bag including the content into a manageable pile while at the same time removing the outer periphery of the bag from the friction knobs located on the interior on both halves of the outer pair of clam shells. It is merely up to the handler to simply pull the trigger 2 upward to thereby open both the first and second pairs of clam shells. The bag can now easily be disposed of at a proper location.

What I claim is:

1. an animal waste pickup device comprising an elongated handle having: an upper and a lower end, said upper end having located thereon a trigger for operating elements at a lower end of said handle, said elements consisting of a pair of first and outer clam shells said first outer pair clam shells having each half of said pair hingedly connected to a housing located at said lower end of said handle, said elements further consisting of a second and inner pair of clam shells located within said first pair of clam shells, each half of said second pair is hingedly connected to a yoke which in turn is connected to a shaft of an electric motor, said motor is located within said housing, each half of said second pair of clam shells having central openings therein, a pickup paper bag is placed into the interior of said second pair of claim shells and is adhered to friction knobs located on an interior wall on each of said first halves of said first pair of clam shells, the paper of the paper bag penetrating through said central openings to be able to adhere to said friction knobs located in said first pair of clam shells.

2. The waste pickup device of claim 1, including a spring located within said yoke to always bias said two halves of said pair of second clam shells into an open position.

3. The waste pickup device of claim 1, wherein said electric motor is a gear drive motor.

4. The waste pickup device of claim 1, wherein said electric motor is operated by a push button located at said upper end of said handle.

5. The waste pickup device of claim 1 including alligator teeth located at bottom edges on each half of said first pair of clam shells.
